(19) United States
(12) Patent Application Publication
(10) Pub. No.: US 2025/0346379 A1
(43) Pub. Date: Nov. 13, 2025

(54) AGRICULTURE DRONE STATION

(71) Applicants: University of Florida Research Foundation, Inc., Gainesville, FL (US); AgriBugs LLC, Tallahassee, FL (US)

(72) Inventors: Darren Rajendranath, Tallahassee, FL (US); David P. Arnold, Gainesville, FL (US); Ian Small, Gainesville, FL (US); Dieter A. Steinhauser, Gainesville, FL (US); Ryan J. Laur, Gainesville, FL (US)

(21) Appl. No.: 19/206,649

(22) Filed: May 13, 2025

Related U.S. Application Data
(60) Provisional application No. 63/646,330, filed on May 13, 2024.

(51) Int. Cl. B64U 80/25; B64U 70/90; B64U 80/30; B64U 101/40; H02S 30/20

(52) U.S. Cl. CPC B64U 80/25; B64U 70/90; B64U 80/30; H02S 30/20; B64U 2101/40; B64U 2201/104

(57) ABSTRACT

An exemplary drone station of the present disclosure comprise a platform support; a landing platform configured to charge a drone that is positioned on the flat platform, wherein the landing platform is mounted on a top of the platform support; a Real Time Kinematic (RTK) Global Positioning System (GPS) antenna mounted on the landing platform; a house computer configured to control and monitor operations of the drone landing platform system that include battery management and communications with the drone; a dome enclosure surrounding the landing platform that is configured to open and close around the landing platform; and/or an internal battery, wherein the internal battery supplies power to the landing platform.

### CROSS-REFERENCE TO RELATED APPLICATION

This application claims priority to co-pending U.S. provisional application entitled, “Agriculture Drone Port,” having application No. 63/646,330, filed May 13, 2024, which is entirely incorporated herein by reference.

### STATEMENT REGARDING FEDERALLY SPONSORED RESEARCH OR DEVELOPMENT

This invention was made with government support under grant no. 1941529 awarded by the National Science Foundation. The government has certain rights in the invention.

### BACKGROUND

Agribugs, a Florida based company, is automating agricultural survey operations by using drones equipped with precision landing gear and leveraging artificial intelligence (AI) to accurately predict yields. Agribugs' aim is to help crop consultants and research scientists make well informed, real-time decisions on crop health and pest control.

Agribugs currently uses a series of off-the-shelf systems and human operators to gather the desired agricultural data. Complications of isolated systems, skilled human operation, and weather conditions limit the quantity and quality of data collected. Working towards a unified station that provides a drone shelter along with charging, data interpretation functions, and remote user interaction will allow for widespread deployment of agricultural inspection drones and mitigate the previously stated complications.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an exemplary drone station in accordance with various embodiments of the present disclosure.

FIGS. 2A-2G show an exemplary drone station in accordance with various embodiments of the present disclosure, where FIG. 2A shows an upper view of a closed dome and solar panels; FIG. 2B shows the a lower view of a drone housing area that provides a mount for attaching the housing area to multiple surfaces; FIG. 2C shows the housing area with the dome removed to reveal landing charging pads and Real Time Kinematic antenna; FIG. 2D provides an exploded view that illustrates where a house computer system can be located; FIG. 2E shows representative locations for battery storage and sensors at feet pads of a platform support (e.g., a tripod mount); FIG. 2F shows an exemplary drone station with an auxiliary landing and charging pad for an unmanned ground vehicle; and FIG. 2G shows an exemplary drone station with auxiliary solar panels for the drone station that are configured to shelter an unmanned ground vehicle.

FIG. 3 is a block diagram of an exemplary drone station in accordance with various embodiments of the present disclosure.

FIG. 4 is a block diagram of a house computer and remote/cloud system in accordance with various embodiments of the present disclosure.

FIG. 5 is a diagram of a local area network deployed by the drone station in accordance with various embodiments of the present disclosure.

FIG. 6 shows a graphical user interface display for current weather information in accordance with various embodiments of the present disclosure.

FIG. 7 shows a code flow diagram for flight in accordance with various embodiments of the present disclosure.

FIG. 8 shows a power chain block diagram in accordance with various embodiments of the present disclosure.

FIG. 9 is an image of a drone positioned on a prototype of a drone station landing pad in accordance with various embodiments of the present disclosure.

FIGS. 10A-10B show exemplary drone station landing quadrants and H-bridge in accordance with various embodiments of the present disclosure.

FIG. 11 shows a battery polarity detection circuit in accordance with various embodiments of the present disclosure.

FIG. 12 shows a graphical user interface as a standalone window in accordance with various embodiments of the present disclosure.

### DETAILED DESCRIPTION

In the present disclosure, systems, methods, and non-transitory computer-readable media are disclosed for an autonomous drone station and related operations, such as for agricultural purposes and environments. In various embodiments, an exemplary drone station features a smart power management system and a remotely accessible user interface for station data.

In accordance with embodiments of the present disclosure, an exemplary drone system is configured to acquire and collect aerial imagery data for the purpose of high precision accurate three-dimensional (3D) reconstruction of environments in a small form factor. Such a system is able to be operated remotely as a stand-alone device where power and cell tower accessibility is restricted. Data can be captured by an unmanned aerial vehicle (e.g., drone) and/or an unmanned ground or surface vehicle (e.g., land rover vehicle) and sent to an internal integrated computer of the drone system for processing where data analytics can be distributed to local onsite machinery which will result in an automated task being performed, as specified by a remote user.

Current drone in the box systems on the market are developed with larger drone systems for remote data collection. Systems of the present disclosure, however, involve a smaller drone (e.g., weighing under 500 g) with a smaller housing system in a drone station that utilizes multiple different technologies organized in a compact design for easy deployments. An exemplary drone station will be able to be mounted to multiple types of devices in the fields via tripods, vehicle roof tops, tractor ceilings, and/or building ceilings utilizing a magnet or screwed mount, or other type of fastener.

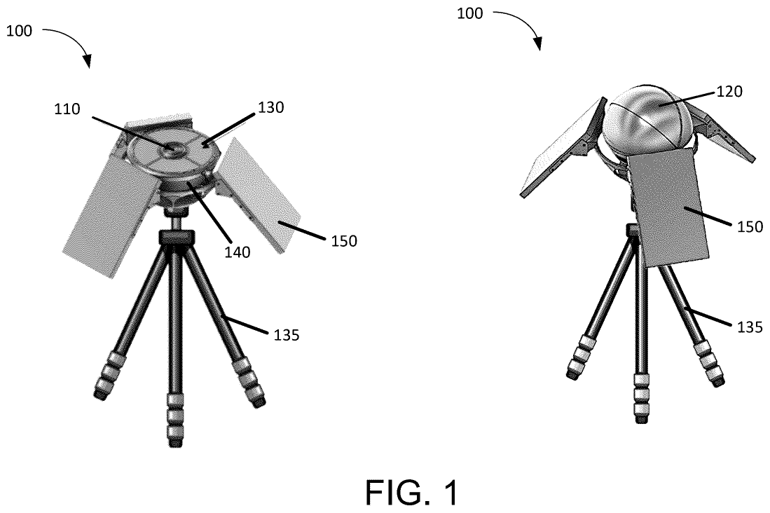

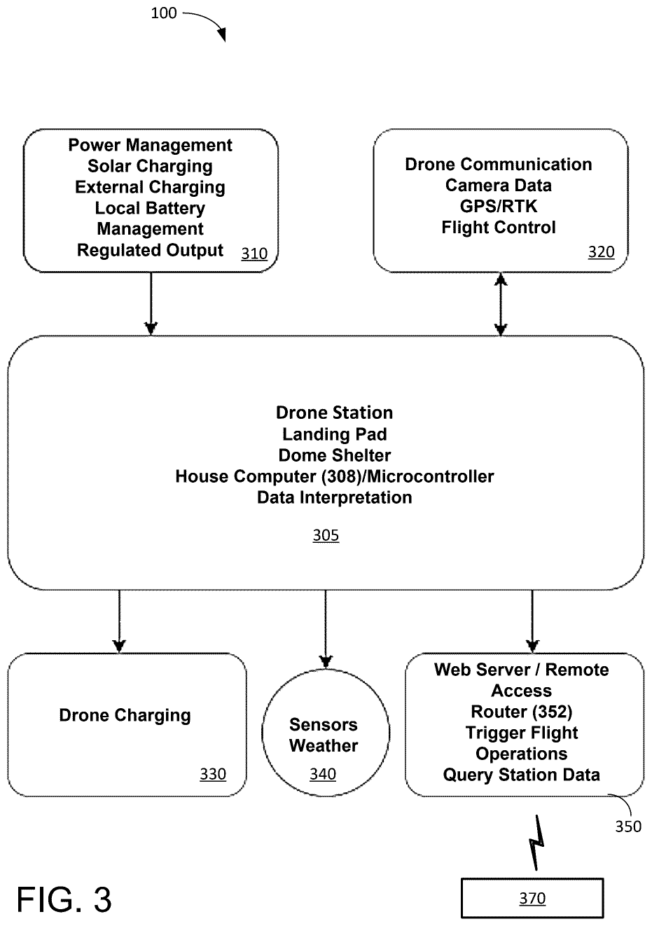

As illustrated in the left and right views of FIG. 1 showing an exemplary drone station 100, a RTK (Real Time Kinematic) system or module 110 is mounted in the center of a drone housing area for accurate global positioning system (GPS) data collection and precision accuracy of image tagging for accurate 3D reconstruction of any environment. The housing contains a dome 110 for covering an unmanned aerial vehicle or drone for protection from weather during inoperability. The dome 120 will be opened and closed remotely via a web accessed system. In various embodiments, a router 353 (FIG. 3) for monitoring and controlling of the drone system and housing is mounted within the center of a drone landing pad 130 within an interior of the dome enclosure. In various embodiments, the landing pad 130 comprises a charging center configuration that can be used to charge a power supply for the drone. In various embodiments, the landing pad with its charging pads 130 can charge the drone either wirelessly or via point to point contact via the landing charging pads.

In various embodiments, the drone station 100 comprises a tripod 135 or other type of mounting platform to support components of the drone station 100, such as the dome 120 and its internal components.

In various embodiments, operations of an exemplary drone station 100 includes a dome opening and a drone launching to carry out multiple data analysis operations. The drone may then return to housing system with the dome 120 opening for landing on the landing pad and its charging pads 130. Once landed, the dome 120 may automatically close and charging of the drone may commence. Data from drone will then be transferred to a house or internal computer 140 of the drone station 100 for data processing and transporting to a remote file/web server 370 (FIG. 3). The house computer system 140 can be configured to control camera system(s), RTK system, remote drone operations, charging system(s), and any other operations of the system. Solar panels 150 and other external power harvesting mechanisms can be utilized to charge an internal battery (contained with a housing) of the drone station 100 to operate the drone station 100 and its related components.

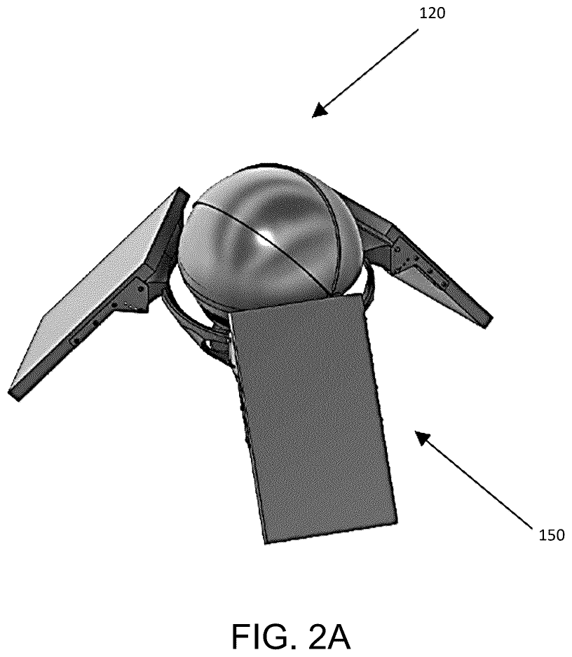

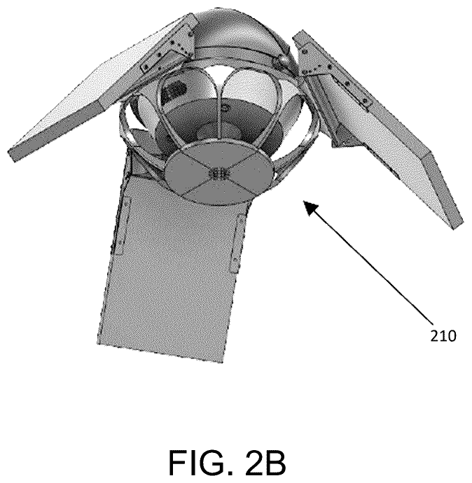

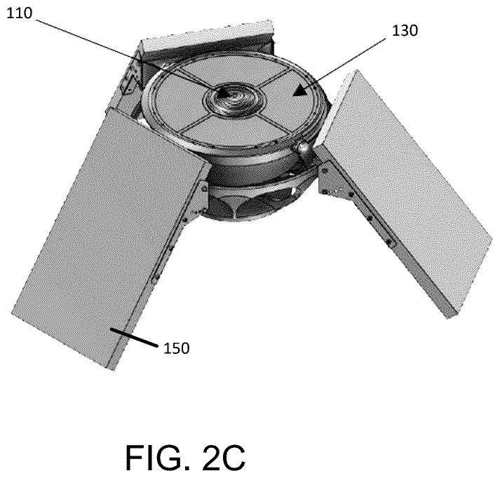

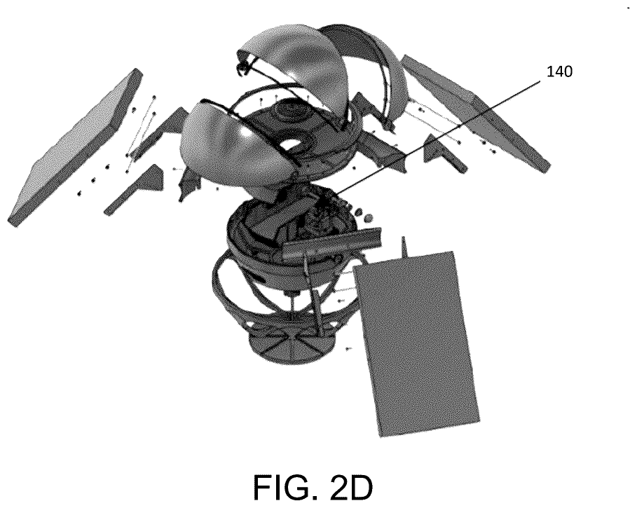

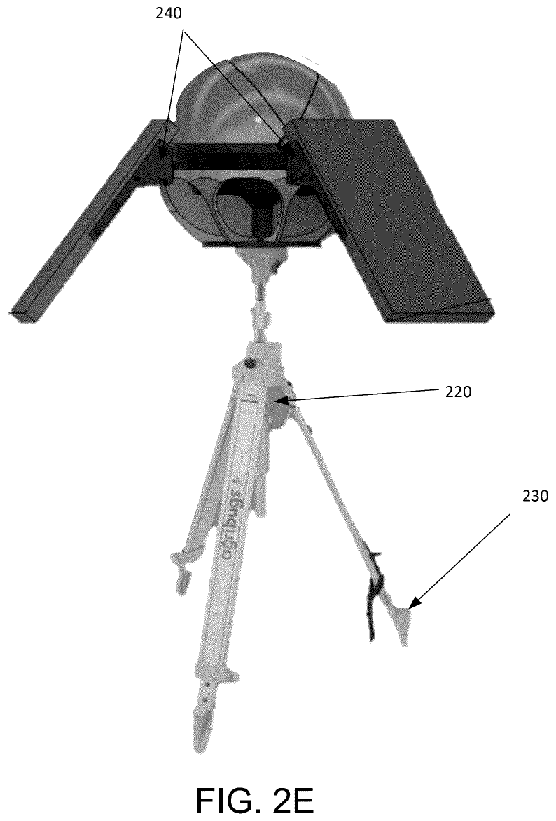

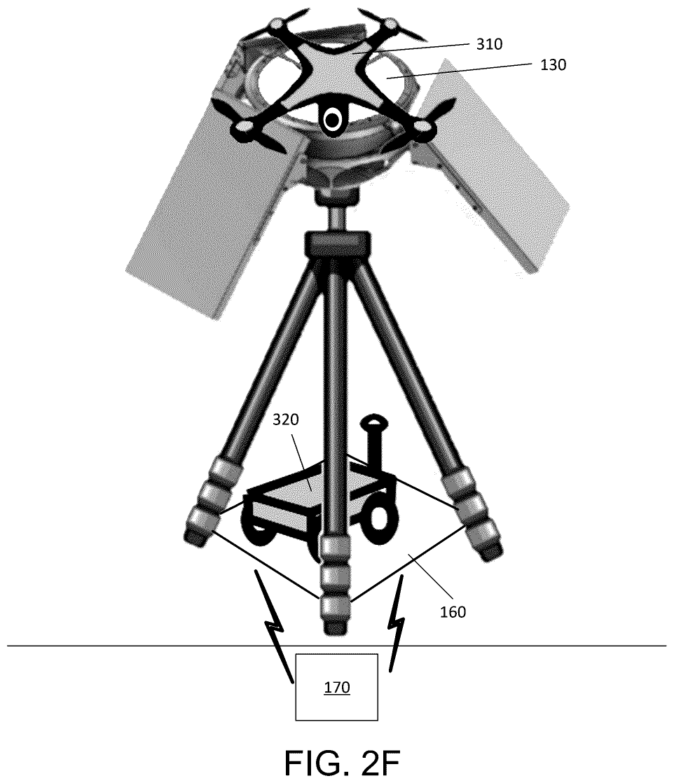

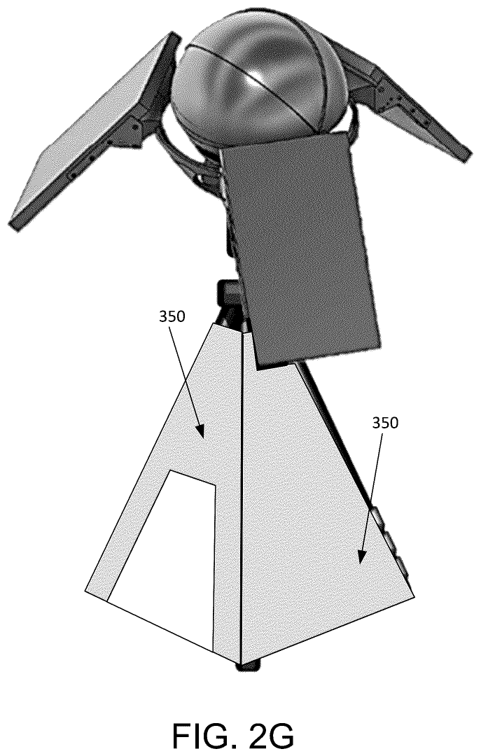

Additional view are provided in FIGS. 2A-2E for an exemplary embodiment, where FIG. 2A shows an upper view of the closed dome 120 and solar panels 150; FIG. 2B shows a lower view of the drone housing area that provides a mount 210 for attaching the housing area to multiple surfaces; FIG. 2C shows the housing area with the dome 120 removed to reveal the landing charging pads 130 and RTK antenna 110; FIG. 2D provides an exploded view that illustrates where the house computer system 140 can be located; and FIG. 2E shows representative locations 220, 230 for battery storage and sensors at the feet pads of a platform support (e.g., a tripod mount). Accordingly, sensors, such as moisture sensors, at the feet of an exemplary tripod can collect and transfer data of ground material to the house computer 140. Additionally, sensors can be mounted at various locations, such as locations 240, of an exemplary drone station, such as those for weather and drone operation surveillance. For example, additional mount locations 240 can also be used for a camera system for weather and drone operation surveillance.

Referring now to FIG. 3, the figure shows a block diagram of an exemplary drone station 100 in accordance with various embodiments of the present disclosure. The drone station 100 includes a base station 305 comprising a landing pad 130, a dome shelter 120, a house computer 140, and other circuitry or modules (e.g., data interpretation circuitry, etc. Additionally, an exemplary drone station 305 further includes power management circuitry and/or modules 310, drone communication circuitry and/or modules 320, drone charging circuitry and/or software modules 330, sensor(s) 340, and web server/remote access circuitry and/or software modules 350.

In various embodiments, the power management circuitry/module(s) 310 can include solar charging circuitry and/or modules, external charging circuitry and/or modules, local battery management circuitry and/or modules, regulated output circuitry and/or modules, etc.

In various embodiments, the drone communication circuitry/module(s) 320 can include camera data circuitry and/or modules, GPS and RTK circuitry and/or modules 110, flight control circuitry and/or modules, etc. In implementing drone control and communication, an RF telemetry system between the drone and base station can be utilized, such as an RFD 900 MHz bundle.

In various embodiments, the web server circuitry and/or modules 350 can include router circuitry 352 and/or modules, trigger flight operations circuitry and/or modules, query station data circuitry and/or modules, etc. for communicating with an external or remote server 370.

Thus, various embodiments of an exemplary drone station 100 of the present disclosure includes a wide variety of features including, but not limited to, a RTK GPS antenna 110 mounted in the center of a landing pad 130 for charging a drone, where the landing pad or platform contains conductive material for point-to-point charging for a drone; a flat landing platform with a center hole for mounting the RTK GPS antenna 110; an underneath panel having a conductive material for wireless charging of devices (e.g., unmanned ground vehicle) and drone; wires interconnecting the charging pad and/or wireless charging mechanism to an internal battery; solar panels 150 and/or other external power harvesting mechanisms providing power to the internal battery; a covering mechanism for protection of the drone, GPS system, computer system, and internal charging system; a dome structure 120 comprising three separate pieces in which together create a closed covering for the platform; a mechanism and motor for opening and closing of the dome structure 120; a smart tripod system 135 for storing batteries for providing power to the drone landing platform and computer control system; in which the tripod 135 may utilize its legs as a battery containment system; a battery system connected to a battery management system; the battery management system connected to solar panels 150 for charging of batteries; a charging system connected to conductive material for point-to-point charging; legs of the tripod 135 having feet with moisture sensors for collecting data that can tell the drone when to operate for moisture tracking of the environment; an integrated house computer system 140 connected to all devices for controlling and monitoring of remote operations; in which the computer system 140 may comprise a battery management system; in which the computer system 140 may comprise a system designed for controlling and communication with the drone; a radio system for controlling the drone; a solar charging system having (a) solar panels 150 setup up in arranged around the drone station 100, (b) solar panels 150 connected internal battery management system, and (c) a battery system to provide power to drone charging system, computer system, and internal components; in which the computer system 140 may comprise a decision support system; one or more camera systems for continuous monitoring of the drone; camera system mounted in multiple locations for creating a 360 degree view for drone trajectory; a camera system for tracking weather conditions such as clouds for the fundamentals of capturing accurate data; a 1 inch or larger camera sensor; a drone that weighs under 500 g with an intelligent camera system; a flight controller system that is directly connected to a camera sensor with gimbal; a drone fuselage able to pivot for capturing pictures while staying level; a battery system able to fly for 1+/− hr.; a system where batteries and capacitors are the arms of the drone; an RTK GPS antenna for connecting to base landing station; other sensors such as LIDAR for accurate depth measurements; and/or power harvesting technologies, such as solar panels, systems used to harvest power from the ground or below the ground connected to internal battery, a system for distributing power wirelessly to peripherals, connected power sources such as an irrigation system power connection and water powered turbine, utilizing hose from irrigation system to generate power from water movement; and/or any external power source connected to the system.

A primary task, among others, of the drone station 100 is to provide a landing zone and shelter for the autonomous drone (e.g., quadcopter drone). Additionally, the drone station 100 can function as a central communication point between the autonomous drone and the remote user. Communications between the drone and the station can include GPS/RTK, camera, and flight controls data. In various embodiments, the drone station 100 is configured to have an internet connection for remote access of media and systems. Solar charging can also be utilized for long-term field operation, such that the drone station can charge the drone without user intervention.

In various embodiments, an exemplary drone station 100 serves as an autonomous drone station for deployment in agricultural environments and requiring minimal human intervention, thereby creating an autonomous drone system to gather agricultural data for research interpretation of crop health. As such, the drone station 100 acts a hub for drone charging 330 and data upload to a remote file/web server (e.g., cloud storage). Accordingly, the autonomous agricultural drone station can serve as a landing base, hangar, solar energy collector, recharging platform, data collector, and communication hub for a quadcopter drone. In various embodiments, duplex communication is provided between a remote-control graphical user interface (GUI) and the drone station. System integration of the solar charging, power management, environment sensors, data collection, and a web server are discussed in the following section of the present disclosure.

As such, embodiments of the present disclosure are designed and configured to implement solar and AC/DC battery charging; implement power management and protection circuitry while remaining efficient; detect and sense voltage and current of various power rails to determine energy statistics; deploy a web server graphical user interface (GUI) for interaction with the droid station 100; integrate systems with an existing Agribugs drone landing station; and communicate with the drone for flight control and mission planning.

To provide station management, the house computer 308 is configured to initiate data transfer from the drone to a file/web server 370 (e.g., media server), log mission critical data, manage weather data, and make camera data available to the user. In various embodiments, once the drone lands back at the drone station, a Wi-Fi data dump commences, and the house computer 308 is configured to encode data into a remote viewing format and make the data available for viewing on the file server 370. In various embodiments, the camera data from the drone can be used to create an orthophoto or Ortho map to analyze crop health.

In various embodiments, an exemplary drone station, in addition to having a landing and charging pad 130 for unmanned aerial vehicles, contains a charging pad for unmanned ground or surface vehicles, as demonstrated in FIG. 2F. Here, an unmanned aerial vehicle or drone 310 is shown to be positioned on the landing pad 130 and an unmanned aerial vehicle 320 is shown to be positioned on an auxiliary landing and charging pad 160 that is equipped with charging pads similar to the landing pad 130 and is located under the dome 120 of the drone station 100. In various embodiments, the auxiliary landing pad 160 is situated between legs of a tripod 135 of the drone station 100.

In various embodiments, in addition to solar panels that are equipped to generate electrical power to the drone station 100 from solar radiation, the drone station 100 may also be coupled to an underground power supply 170, such as one or more buried batteries, that feed into a power management system of the drone station 100.

In various embodiments, the drone station 100 may be able to charge and power both the unmanned aerial vehicle 310 and the unmanned ground vehicle 30 simultaneously. Further, in various embodiments, an exemplary drone station 100 may be able to transmit and receive telemetry data from both the unmanned aerial vehicle or drone 310 and ground vehicle 320 locally after docking to the landing pads 130, 160 and to an external file/web server 370. Additionally, the drone station 100 may facilitate for streaming communications in parallel between camera systems integrated in the aerial and/or ground vehicles 310, 320 in the field and the external or remote server system 370 for real-time monitoring. Thus, in various embodiments, one video transmission system of the drone station 100 can be utilized for both aerial and ground vehicles for data collection and processing, while utilizing the same protocol in parallel for environmental reconstruction in a virtual interface. For example, the drone station 100 may use GPS information or an area of interest (provided from a user interface to the drone station) to provide location data for modeling. Accordingly, area of interest may be extracted from satellite images and GPS information and sent to the drone station. This GPS information can relay areas where the multi-vehicle system can be sent to in order to perform an imaging task. Accordingly, such information can be communicated to aerial and ground vehicles 310, 320 by the drone station in order to image a specific area by the respective vehicles.

For example, the aerial vehicle 310 can utilize the GPS information to capture Nadir image data while the ground vehicle 320 can capture oblique images from the ground. The capture image data (along with GPS location information) may be sent to or outputted to the drone station 100 and its house computer 140 for further processing.

Accordingly, in various embodiments, the ground vehicle 320 may be equipped with one or more cameras, such as on an interior roof of the vehicle, that can be used for capturing imaging data, such as images of samples from an agricultural field. Correspondingly, in various embodiments, the ground vehicle 320 may be equipped with a gripper arm attached that is configured to pick up or capture samples from an agricultural field and deposit the collected sample(s) in a container on a top of the vehicle that is positioned below a camera that is configured to capture an image of the sample(s) within the container.

The types of data information relayed from the aerial and/or ground vehicles 310, 320 to the drone station 100 can include telemetry data, GPS and/or time information, sensor information, and imaging data, among others. In various embodiments, the housing computer 140 may communicate with one or both vehicles with instructions on how to capture data for accurate and precise environmental reconstruction.

In various embodiments, as demonstrated in FIG. 2G, the drone station 100 may include auxiliary solar panels 350 that are equipped to generate electrical power to the drone station 100 from solar radiation, in addition to providing shelter to the landing pad 160 and/or the ground vehicle 320 disposed within a cavity defined by the auxiliary solar panels 350 and the shape of the frame of the drone station (e.g., tripod legs 135) to which the auxiliary solar panels 350 are attached. In various embodiments, one of the auxiliary solar panels 350 may contain an opening or door through which the ground vehicle 320 can enter and exit.

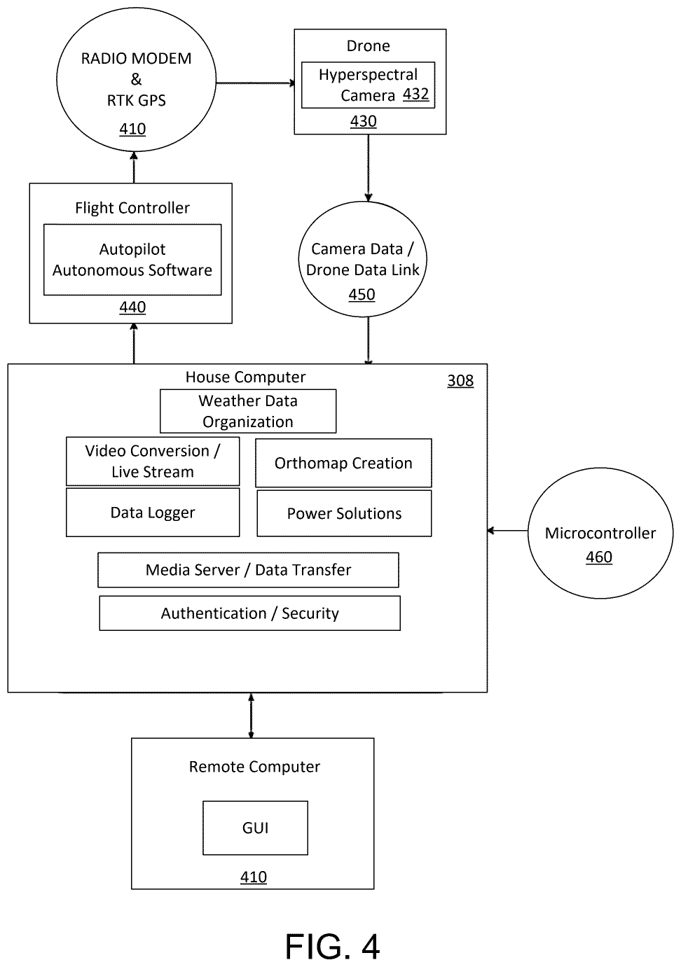

FIG. 4 is a block diagram of a house computer and remote/cloud system 400 in accordance with various embodiments of the present disclosure. As represented in the diagram, the system includes a house computer 308 (e.g., house computer 140), a remote computer 410 with remote GUI, radio modem and RTK GPS circuitry/modules 420, drone 430 with camera system, flight controller software 440 including autopilot autonomous software, camera data/drone data communication link 450, and a microcontroller 460. Functions performed by the house computer 308 include video conversion and live streaming, data logging, weather data organization, Ortho map creations, power solutions, media server and data transfer operations, and authentication/security operations.

In various embodiments, drone control and automation can be programmed from the main PC using PixHawk flight controller software 440. The PixHawk is a commonly used open-source flight controller that provides a low cost, high-end solution to drone automation.

In one embodiment, the house computer 308 comprises a Beelink mini-PC device that has four USB ports—3 USB3.2 ports and 1 USB 2.0 port. The USB ports are configured to communicate with the other devices. Other features include Wi-Fi 6, Bluetooth 5.2, ethernet, HDMI, and a 500 GB SSD. The Beelink PC can run Windows or Linux operating systems. Power consumption on the Beelink idles around 10 W, but maximum power draw is documented to be 60 W.

In one embodiment, the microcontroller 460 comprises a Raspberry Pico device. The Raspberry Pico is a development board with an RP2040 microcontroller chip. It has 264 KB of SRAM and 2 MB of flash memory. Development for the Pico is versatile as the platform capable of being programmed in MicroPython, CPython, C, and Rust. The Pico has a dual core processor with a warrantied clock speed of 133 MHz, set to 125 MHz out of the box. The Pico is easily overclocked to over double the stock processor speed, with simple overclocking available to 270 MHz. There are 40 GPIO (General Purpose Input/Output) pins on the board, with SPI, I2C, and UART communication capability. The Pico comes equipped with a 12-bit 500 ksps analog-to-digital converter (ADC) with 5 channels total. One channel is configured to an RP2040 internal temperature sensor, and three are tied to GPIO pins on the Pico. The Pico also has a timer with four alarms, a Real-Time-Counter (RTC), and sixteen Pulse-Width Modulation (PWM) channels. The Pico also comes in a Wi-Fi and Bluetooth enabled version called the Pico W and are effective low power devices.

In one embodiment, JUCE serves the backbone for developing the Graphical User Interface (GUI) for the remote computer and facilitates the efficient management of resources, threaded processes, and visual components. In particular, JUCE Is an open-source C++ application framework, specifically used for its robust handling of complex user interfaces. JUCE and C++ both provide tools to handle background tasks and user interactions seamlessly and contains drawing elements, menus, and event-driven listeners to provide control and feedback to the user. This will ensure that the GUI and controls remain responsive while handling intensive tasks like server communication, and data transmission.

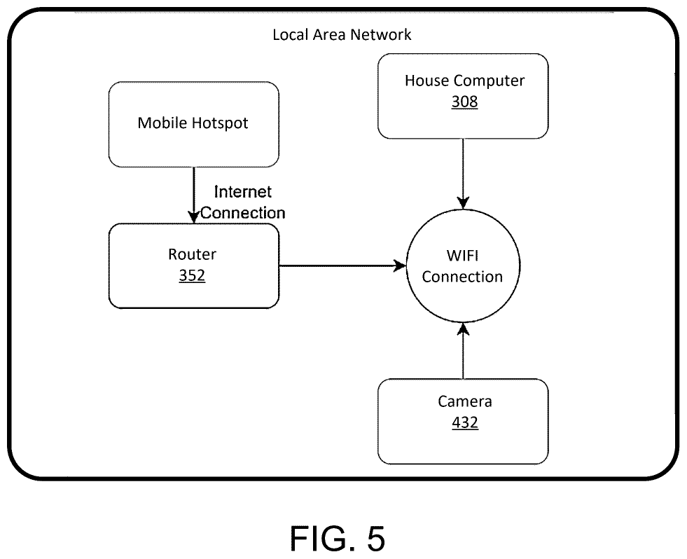

FIG. 5 provides a diagram of a local area network deployed by an exemplary embodiment of the present disclosure. Accordingly, for providing local network access, in one embodiment, a TPlink AC750 travel router is deployed to create the local network on the drone station 300 If a wired modem connection to the router 352 is present, the router 352 can create a Wi-Fi network and produce an SSID. If a mobile hotspot is used, the SSID and password can be the same as the mobile hotspot. Either way, the travel router 352 can be configured to create a robust local area network (LAN) for devices such as the house computer 308, microcontroller 360, camera system(s) 432, and other wireless devices to connect.

In an exemplary implementation, to configure the internet service, a mobile hotspot was used in conjunction with a TP-Link AC750 wireless router 352. In the setup options, the WIFI extender mode was selected, and then the wireless 5 GHz was set up with the desired hotspot. After this setting was enabled, the travel router 352 is configured to act as a range extender for the mobile hotspot, rebroadcasting the SSID of the mobile hotspot network. This effectively allows for access to the wide area network (WAN) or the internet while also having the benefits of a strong and dedicated LAN. In various embodiments, the drone station may use either a 4G-LTE modem or satellite internet modem for WAN/internet connection, such that the AC750 router 352 may be reconfigured to act as a router instead of a range extender.

In one embodiment, the camera 432 comprises an ESP32 Wireless drone camera. The ESP32-CAM is a system from AI-Thinker that is used to act as both the microprocessor 360 and camera 352. The ESP32-CAM takes pictures on a 2 second interval In some embodiments, a higher quality camera system may be used that communicates directly with the drone.

In various embodiments, the ESP32-CAM is configured to create a server once connected to the internet. HTTP requests are made from the GUI to the ESP32-CAM, and when a request is made, the ESP32 will begin taking pictures. Once it is finished taking the pictures, it will read them from an SD card and upload the photos by sending an “image/jpeg” request to the web server address.

In one embodiment, weather information is updated from a network website (https://wttr.in/) that provides weather data for the current GPS location in JSON format. In various embodiments, a fetchWeatherData( ) function will first check if the internet is connected, and then create a new thread to parse the JSON file, evaluate the current conditions, and update the display.

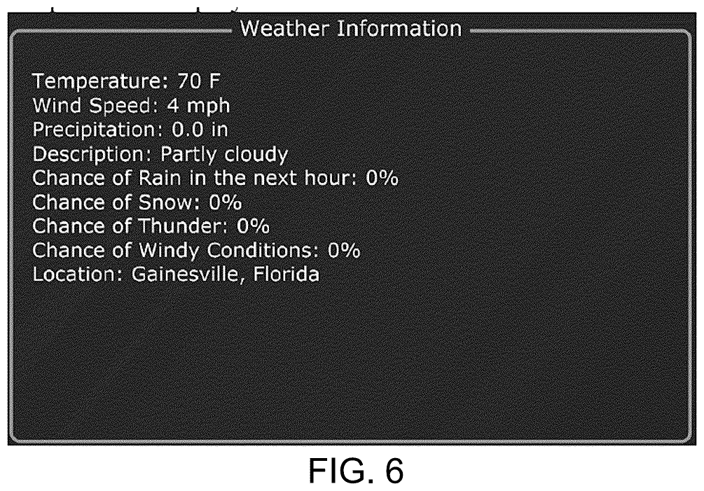

From the web server, a GUI weather display can show the current temperature, wind speed, precipitation, current conditions, and information on if there is going to be adverse weather conditions in the next hour. In various embodiments, GUI operations are performed asynchronously outside of the weather thread in case there is a timeout when requesting data from the website. Fetching the weather data occurs on a timer, which varies depending on the battery state. The weather will not update if the battery is on critical mode, and will update much faster if the battery is charging/in performance mode. FIG. 6 shows an exemplary GUI display for current weather information.

On an additional GUI display, a GUI measurement table is provided where all the power system data is displayed, in which the GUI waits for serial data to be received, and then updates the GUI accordingly. A buffer is used to store the COM serial data, which contains an ID, and a corresponding value. The ID pertains to component to be updated, and the values are what should be displayed.

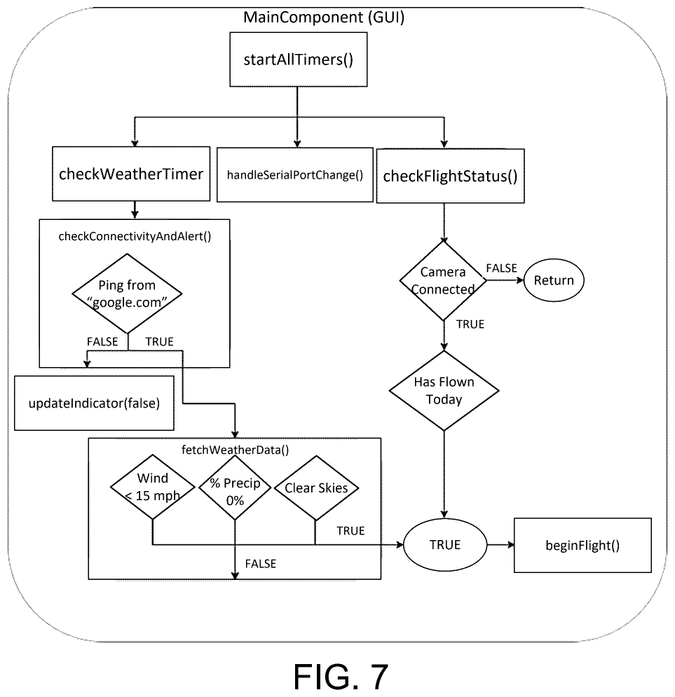

In various embodiments, the house computer 308 executes a drone flight state machine upon which several states and flags manage the logic for determining whether a drone is ready to fly, which will signal pictures to be taken on the ESP32. The decision comes from several hardware connectivity checks, weather data validation, and timer-based functions. The state machine flowchart in FIG. 7 depicts the implementation through several functions within the MainComponent class of the control station.

In an exemplary embodiment, the house computer checks internet connectivity by attempting to ping an external server (google.com). If the ping request succeeds, it will then fetch and process weather data from wttr.in, with failed attempts managed in a separate threaded process. During the weather check, it determines if there are Sunny, Clear, Cloudy, or Overcast skies, with clear skies and wind speeds less than 15 mph. If there is no precipitation forecast for the next hour, then it proceeds. On a separate parallel process, the house computer evaluates the connection status of the camera 432 and the microprocessor 360 and whether the drone has already completed a flight for the day. This evaluation is necessary to prevent repeated operations and ensure the drone's operations are limited to the operational time window between 8 am and 4 pm.

While the flight function is being executed on a separate thread, the main thread will asynchronously log the status of flight to the UI window, and a log file located in a program directory. Threads are cleaned up on a timer and joined appropriately to save resources. Incoming data is processed on a new thread when the listener callback function is triggered. The listener is waiting for data from the ComDevice object, and it retrieves the next ID its associated value from a buffer. It then iterates through a batch of power data and updates the GUI components, accordingly, based on the ID (component), and value (voltage or current). The labels are only updated if changed.

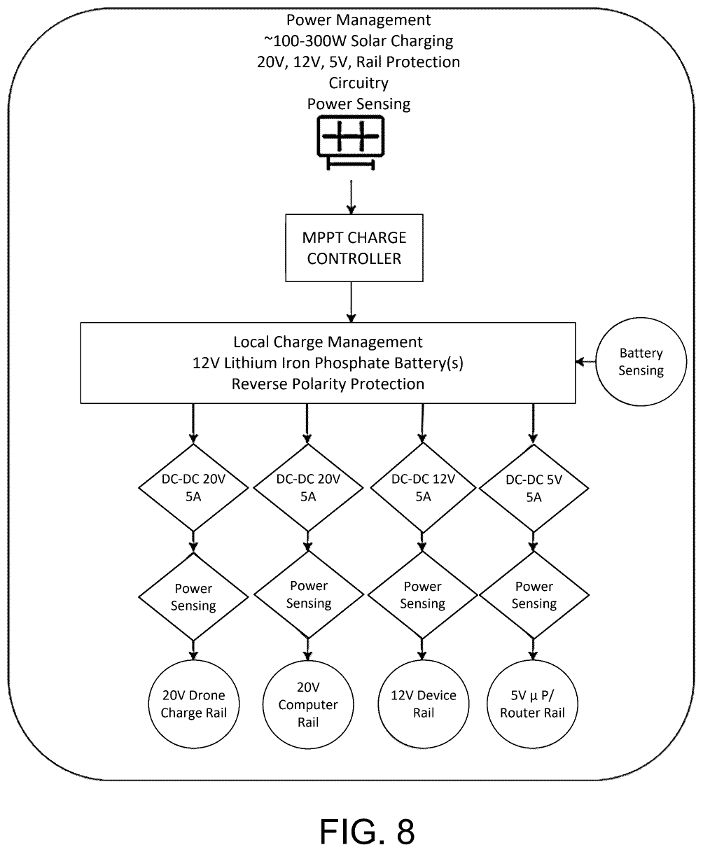

FIG. 8 shows a power chain block diagram in accordance with various embodiments of the present disclosure. For example, an exemplary autonomous drone station can utilize a robust power management system for long term field operation and future expansion. In one embodiment, a 30 W solar panel and charge controller is used for solar charging of the station. Alternatively, a larger panel configuration can be utilized for operation of the system. In various embodiments, a 12V Lithium Iron Phosphate battery bank can be used to store and supply energy to the station. Voltage and current measurements can occur at the maximum power point tracking (MPPT) solar controller and battery to observe charging and discharging. In various embodiments, various electronics on the station can utilize DC/DC buck-boost power rails for continuous and efficient operation. A 20V/5 A rail can be implemented for drone charging support. A buck-boost converter can also be used for a 20V/5 A rail to provide power to the onboard house computer. Smaller devices such as motors, sensors, microcontrollers, can be configured to rely on 12V/5 A and 5V/5 A rails respectively. Each DC-DC rail can have power protection circuitry for overcurrent and overvoltage conditions. Additionally, all output rails can be measured and filtered before supplying the station with power. Measurements can be read into the microcontroller for interpretation and can send collected data to the main/house computer.

In various embodiments, a series of Texas Instruments (TI) evaluation boards can be incorporated for both the MPPT charge controller and DC/DC converters. Efficiency of devices is 95% or higher at load and they feature current and voltage limiting. Implementation of sensing circuitry can also be incorporated in the drone station.

In various embodiments, the drone station can have various systems continuously powered for remote access, including the main/house computer and networking hardware. It is understood that the device load is pertinent for solar and battery storage calculations. Device loads also vary with idle and active processes.

Depending on networking configuration, the drone station will have varying power demands. In various embodiments, Starlink internet provides a more robust network connection in rural areas with little cellular reception, although this implementation results in a higher power draw at load and idle, with additional hardware needed for DC conversion of the Starlink hardware.

In various embodiments, drone station power consumption can be observed in active and idle operation modes. This allows for the main computer to process Ortho map data, upload data to the cloud, and charge the drone. A large majority of the day the drone station will be in idle mode, reducing power consumption as much as possible. In various embodiments, ˜100 Ah battery and at least a 150 W panel solution are utilized for field operations.

In various embodiments, an analog to digital converter (ADC) is integrated on the Raspberry Pico microcontroller, where an initial setup of the ADC can easily be achieved using the ADC section of the Pico Software Development Kit (SDK). This provides an engineer with a simple and straightforward introduction on taking ADC readings. However, the 12-bit ADC onboard the Pico is not ideal when unaltered with 8.7 as the effective number of bits. This is due to the switching power regulator on the Pico which can have as much as 200 mV Vpp of noise. As a result of switching noise, the onboard voltage reference for the ADC is setup in poor conditions. There is an RC filter feeding the ADC reference which creates a 30 mV offset with a slightly less noisy signal. In various embodiments, an external reference voltage may be used, the R7 resistor of the microcontroller can be removed, or issues can be mitigated in averaging and offset code in order to improve ADC readings.

In various embodiments, the ADC reference is disconnected from the Pico power chain entirely by removing the R7 resistor from the microcontroller, such that a reference can be made using a TLV431 adjustable voltage reference. For low power consumption, in various embodiments, a LM4040 3V micropower voltage reference is implemented instead and is fed from the 5V rail using a 1K ohm resistor and filtered using 100 nF decoupling capacitors. In addition to feeding the ADC, in various embodiments, the 3V reference is buffered and used for the creation of precise voltage references used elsewhere.

Precise voltage references are desired for comparison circuitry throughout the power measurement system. The most prominent voltage references required are for the current sensing system. In various embodiments, a 2.5V reference is used for a bidirectional current sensor, while a 50 mV reference is used for the unidirectional current sensors. This allows for the current measurements to remain accurate, especially when the amplifiers operate close to the ground rail.

References can be made using the 5V rail, resistor dividers, and voltage buffers. This allows for the references to be made with high resistances and minimizes current and power usage. The voltage buffers are implemented to create a low output impedance compared to the Thevenin equivalent circuit made by the voltage divider. LM358 op-amps can be chosen because they are cost effective, have relatively low quiescent current (350 uA typ, 600 uA max), and can operate in the desired voltage range without clipping. It is believed that input offset voltage is the only downside to using this device, as 2 mV offset is typical and can reach up to 5 mV in a worse case. Feedback resistors may be chosen to match the input impedance seen from both the inverting and non-inverting terminals to help mitigate this flaw. Regardless, the circuitry is more than acceptable for generation of these references and their applications, as other limitations to the circuits such as ADC resolution and current amplifier accuracy exist.

Aside from conditioning the ADC to take precise measurements, many ADC channels are used so that a variety of current and voltage measurements are acquired without intervention and crosstalk. While external ADCs can be implemented, ADC's can be relatively expensive and often come in small surface mount device (SMD) packaging. While this is an area for footprint shrinking in the future, it is believed that it may be more important to have the cost efficiency, debuggability, and general ease of use that is associated with dual in-line packaged (DIP) parts. This severely limits the quality of ADC's when searching. As a result, a different approach can be taken to create a multiplexing circuit to effectively expand the ADC channels on the Pico.

By using a CD4066B bilateral switch, analog signals can be effectively multiplexed with little interference or distortion. ADC channels 0 and 1 have their own CD4066 IC in which they measure voltage and current of the output rails respectively. ADC2 is shared between a mux that measures the battery and a future expansion mux in the case additional current and voltage sensing is desired for drone charging or motor overcurrent. The ADC2 multiplexers are switched between by an intermediate switch. The intermediate switch is controlled by a single GPIO so that one CD4066 connected to ADC2 is always on. This signal is created by using a LM393 dual comparator with a middle logic threshold value of 1.67V. The circuit accomplishes two things, it first performs logic level shifting from 3.3V to 5V while also creating two opposite signals from one GPIO pin.

In various embodiments, each mux is controlled by four data lines. A single data line is set high and all three ADCs are queried before setting the data line low again. This process is limited by the setup and hold time of the ADC, which is approximately 2 μs from the 500 ksps Pico ADC. In Python, 20 μs seems to be a stable setup and hold time for each ADC measurement and allows for every expanded channel to be read in less than 100 μs. For the use case of this project this rate of readings is more than sufficient.

Protecting against reverse polarity conditions helps prevent hardware damage due to user error. This is a safety feature that can be included in an event where a battery or solar charger is connected in reverse. This can be accomplished by implementing a power NMOS or PMOS in series with the power signal. For this type of design, PMOS can be implemented to avoid interrupting the ground reference. This system can also be achieved using a NMOS transistor in a mirrored circuit if interrupting the common ground is not a concern. Assuming the correct connection, current will initially flow through the body diode until the output voltage rises above the PMOS voltage threshold. Once this occurs, the MOSFET will start conducting and provide a low impedance path for current to flow that corresponds to the Rds ON of the MOSFET. This allows for the voltage at Vin and Vout to be essentially the same value. In the event that the connection is incorrect, the body diode will not conduct and the Vgs of the MOSFET will remain at zero, effectively maintaining a disconnected state.

In an exemplary circuit of a reverse polarity protection circuit, an IRF5210 PMOS transistor is used which has an Rds on of ˜60 m Ohms, making the drop over the internal resistance negligible when active. Heat dissipation will occur over this internal resistance, for applications over 1 W it is crucial to apply a heatsink to the TO-220 package device. For the IRF5210, a heatsink can be used when having currents more than 3 A, as the power dissipation on the device is equivalent to P=/2R. Decoupling capacitors may be added to minimize transient spikes in power usage.

One drawback to the reverse polarity protection circuit is the input voltage can never be more than the Vgs allowed by the MOSFET. If the Vgs is exceeded, the device is likely to fail and potentially damage downstream electronics. However, with some simple additions to the circuit, we can increase the maximum input and output voltage. A Zener diode can be added between the gate and source terminals to regulate the Vgs within a certain voltage level. A resistor can also added to provide a connection to ground and provide a difference between the gate and ground, as the gate voltage will rise above ground when the source voltage surpasses the Zener diodes voltage. For the IRF5210, the maximum Vgs is −20V. The IRF5210 is also the most active when the Vgs exceeds-10V. As a result, one can choose to implement a 16V Zener diode to keep the maximum Vgs of the circuit at −16V. This also allows for substitute Power PMOS to be utilized that may have a similar maximum Vgs with different thresholds to remain saturated. Choosing the resistance of R1 is a balance of quiescent current consumption and reaction time. A large resistance can be placed here for less quiescent current at the expense of slower reactions to the input switching polarity, which can be an issue if large capacitance is seen on the output of the circuit.

Similar to how the reverse polarity circuit operates, an output power switch circuit can be incorporated to shutoff power from the battery and charger circuit to the output regulators. This effectively turns off anything attached to the system but does not interfere with the charging of the battery. A switch that is active when open can be connected between the battery source and gate of a PMOS device. This PMOS device also has a large resistance between its gate and ground as a weak pull-down. When the switch is closed, Vgs become zero and the MOSFET no longer conducts. When the Switch is open, Vgs can increase to the difference between the battery voltage and ground, allowing large amounts of current to conduct.

While many of DC/DC converters are equipped with over voltage and over current protection features, it is a good practice to incorporate some protection circuitry for the converters that do not include protections and provide a low resistance path in the event of an overvoltage condition. This can be done in a variety of ways such as overvoltage crowbars or voltage clamping. Overvoltage crowbars effectively trigger at a threshold well above the operating voltage of a rail. This is because crowbars create a shunt to ground when triggered to pop a fuse somewhere in the circuit. This is not an ideal situation for the present power chain as drawing high amounts of current and replacing fuses is a brute force implementation of protection, and other electronics can be damaged in the time it takes for the fuse to break. Therefore, it may make more sense to provide voltage clamping to regulate the voltage if it crosses a specific threshold.

Voltage clamping can be easily accomplished using a Zener diode for low current systems. However, as many of the DC/DC converters in the circuitry can output current in the 5-10 A range, a normal Zener diode would almost immediately fail under such high current. For that reason, active power Zener clamps may be implemented. In this circuit, a Zener diode will start conducting at its internal voltage threshold, but a pass transistor can be used to sink the higher currents of the system. This can be done with a power bipolar junction transistor (BJT) or MOSFET and certain transistors make more sense depending on the desired voltage threshold and the current being shunted. A BJT, which is often configured as a Darlington pair, will become active when the base of the transistor is two Vbe's above ground or approximately 1-1.4V. This is desirable for low thresholds. The main drawback of the power BJT's in this type of circuit is that they cannot sink much current. In contrast, TIP142 has a maximum continuous current specification of 10 A. When a MOSFET is used for this sort of system, activation thresholds are much higher and MOSFETS can often sink more current.

Active power Zener diodes using BJT's can be implemented and chosen based on their simplicity in understanding the cutoff thresholds and their ability to shunt the current that the system will provide. For single BJT's, such as the TIP41, the activation level of the circuit will be around 12.6V. This occurs because the voltage at the base will rise when the diode starts conducting above 12V. When the base voltage increases towards 0.6V, the BJT will start conducting and limiting the rail voltage. While this system does waste current over the BJT, it may be preferred to waste power than to destroy attached electronics.

Monitoring various current and voltages is pertinent for precise power monitoring and smart management of energy in a battery-operated system. While voltage measurements are as simple as measuring the potential difference between two points, measuring current is a bit more complicated. Current can either be measured by sensing the magnetic field induced by a given current, or by measuring a potential difference across a known resistance. The latter is often better for precise measurements of small currents. Current measurement schemes often incorporate a very small resistance to minimize voltage drop over the known resistance. A difference amplifier can then be used with high gain to create a measurable voltage as a ratio to current.

Current measurement can take place at the high or low side of a system load. Current sensing on the low side of a circuit is easier and cheaper to implement because the common mode voltage is effectively zero. However, low side current sensing interrupts the ground reference for the load and cannot detect if the load has been accidentally shorted to ground, bypassing the shunt resistor. High side current sensing can detect load shorts to ground as it monitors directly from the source. Measuring current from the high side does have drawbacks in the form of high common mode voltage. This often requires more expensive differential amplifiers when compared to low side sensing.

Various embodiments implement an INA181 current sense amplifier IC for current measurements. In most rail measurement applications, a 5 m ohm shunt resistor can be used in combination with a 200-gain version of the INA181 IC. This allows for a 1:1 ratio between current measured across to precisely measure 0-5 A. While the INA181 is considered rail-to-rail, amplifiers are non-ideal and can only get so close to their supply rails. In the case of unidirectional measurement, a 50 mV offset can be incorporated to measure zero current conditions. Current and voltage measurements are divided to remain on a 0-3V scale before being sent to the ADC system.

In the case of monitoring the battery and charging system, a similar circuit can be implemented using the INA181 configured in a bidirectional mode. An offset of 2.5V is applied to the INA181 to center the output of the current amplifier in its operating region. A 50V/V gain version of the INA181 is utilized so that a ratio 0.25V:1 A is achieved. This allows for ˜10 A to be monitored in either direction. Similarly, the voltage and current measurements are scaled before being sent to the ADC system.

Charging the battery of the drone station requires careful circuitry to manage the charging. Solar panels can be connected using the reverse polarity circuit to a maximum power point tracking (MPPT) controller. For this controller, an evaluation module (EVM) from TI that accepts a 5-28V input, resistor-programmable output, LED charge indication, and is compatible with the LiFePO4 battery chemistry, can be used.

In various embodiments, chargers are connected to the same charging node via high current Schottky diodes, allowing for both external and MPPT controller system charging without reverse current damaging the chargers. All charging energy is either directed towards the battery or the load circuit depending on current demands. One shunt resistor is used to monitor battery charging and discharging while the other monitors peak charging output. A glass fuse is placed in the current path along with an LED indicator for a blown fuse. The battery will also include a reverse polarity protection circuit to prevent damage to downstream circuitry.

To help achieve smart power management for the base station, the voltage and current measurements can be interpreted to create a battery monitoring system using State of Charge (SoC) tracking. After finding an initial charge estimation upon startup, the battery monitoring system can efficiently monitor the current in and out of the battery over time, also known as coulomb counting. A system of SoC monitoring can be implemented using an Analog Devices SoC tracking algorithm that tracks Battery health, state of charge, and depth of discharge.

The BQ24650EVM is a highly integrated switch-mode battery charge controller made by Texas Instruments that provides input voltage regulation for solar panel support. Features include PWM control, High accuracy voltage and current regulation, charge preconditioning, charge termination, and charge status monitoring. Effectively, this device allows for constant-current, constant voltage (CCCV) charging for 2.1 to 26V batteries while also acting as a maximum power point tracking (MPPT) controller for efficient charging via solar.

The BQ24650EVM is initially set to deliver 2 A of charging current at 12.6V. For the present application, a 5 A current limit with approximately a 14.5V voltage may be preferred. This will allow us to safely charge the battery without stressing the evaluation board or the battery. In alternative implementations of this system, designers may desire to have the maximum current output possible for this board. To change the output voltage and current limit, the R13 and R6 values of the BQ24650EVM circuit can be set to 590 k and 8 m ohms respectively.

In various embodiments, the following DC/DC converters are used for their input and output characteristics, alongside their high efficiency, EMI mitigation system, rich protection features, and overall small size when implemented. First, a TPS1297AEVM evaluation module (EVM) is a synchronous buck converter made by Texas Instruments that can deliver up to 10 A output. The EVM is capable of input voltages between 5.5 and 24V that can be supplied by the battery of an exemplary system of the present disclosure. From the factory, the board can be set to deliver 5 VDC output and can have a 30 mVpp ripple voltage when fully loaded. This board also has 90%+ efficiency, great transient response, relatively low noise, and large current delivery. Accordingly, the EVM performs with greater efficiency at larger current loads which allows for future expansion of devices and systems that require a 5V source.

Next, the TPS55288 integrated circuit (IC) is a programmable Buck Boost converter with an I2C interface made by Texas Instruments. The IC is designed for USB power delivery specifications (USB-PD) and has a wide input voltage range between 2.7V and 36V paired with an output range of 0.8V to 22V. Voltage steps can be taken in 20 mV increments over the entire output range, or smaller steps for limited output ranges, allowing higher resolution voltages. The device has a programmable current limit up to 6.35 A with 50 mA increments within a 5% tolerance. Its datasheet boasts 97% efficiency when under conditions of a 12V input and 20V/3 A output.

In various embodiments, the incorporation of an Inter-Integrated Circuit (I2C) interface requires that a master microcontroller exist to command parameters of the DC/DC converters on startup. In various embodiments, the Raspberry Pico acts as the master device and initializes each of the TPS55288EVM's upon startup. These EVM's are used to create three rails with unique purposes. One rail designated as the VADJ, which was designed specifically for drone charging, can be used on its own and provides constant current and constant voltage regulation for attached battery charging. The second rail that the EVM supplies is designated as the 20V rail and is designed specifically to power an attached computer up to 20 VDC/5 A. With the Beelink computer, this rail can be set to 19V to better match the power supply that came with the Beelink. The last EVM is designated as a 12V rail designed for attached motors and future expansion.

Issues of I2C addressing arise when using multiples of the same device on a single I2C bus. Here, there are three devices that share the same address. While the addresses can be programmed internally on the TPS55288, device memory is reset upon a power cycle and would need to be set differently each time the system is powered on. The TPS55288 can also be programmed to a single alternate address externally; however, this requires editing the EVM hardware and does not provide enough alternate addresses for all three devices being implemented. Therefore, in various embodiments, a I2C switch, such as the TCA9548, is added to the design to swap between channels of communication without needing to edit the end device's I2C address. The I2C switch simply opens or closes channels of I2C communication, effectively acting as a digital switch system. Since speed of communication is not a constraint, the TCA9548 is sufficient for this system. The TCA9548 also provides 8 channels for switching and allows for communication over multiple channels simultaneously. The device is also tolerant to various logic levels and can be easily found in breakout boards.

The DRV8871 is a CMOS H-Bridge Driver IC manufactured by Texas Instruments and can be utilized for both driving motors on the drone station but also for the drone charging circuit. The DRV8871 H-Bridge Driver board is a versatile H-Bridge driver that can operate between 6.5V and 45V and supply up to 3.6 A. Control of the DRV8871 can occur with both 3.3V and 5V logic with static and PWM control schemes. Current limiting is determined by an external resistor, enabling overcurrent protection on the device.

In various embodiments, a micro Python driver has been developed for the DRV8871 that allows for PWM control of the H-bridge using two GPIO pins from the Raspberry Pico. Given correct wiring, the microprocessor can control the flow of current and the duty cycle to which it is pulsed. As a result, a developer can easily command the H-bridge into a forward, reverse, coast, or brake state. The developer can also determine the duty cycle for which the system should be active and if the H-bridge reverts to a braking or coasting state when off.

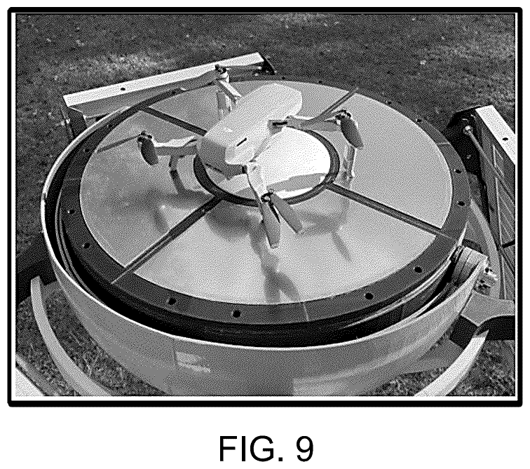

FIG. 9 shows an image of a drone positioned on a prototype of a drone station landing pad in accordance with various embodiments of the present disclosure. To charge the drone that lands on the station, various embodiments implement a conductive charging method for efficiency and to minimize weight of charging circuitry on the drone. In various embodiments, this landing incorporates four metal pads in each quadrant of a circle. To develop charging using this landing pad, it is assumed that the drone can safely and correctly land on the pad without errors in orientation. The second assumption is that the batteries that are attached to the drone can balance their own cells.

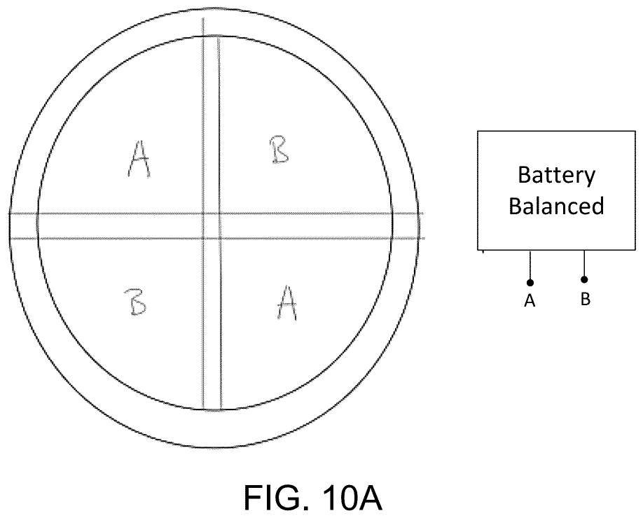

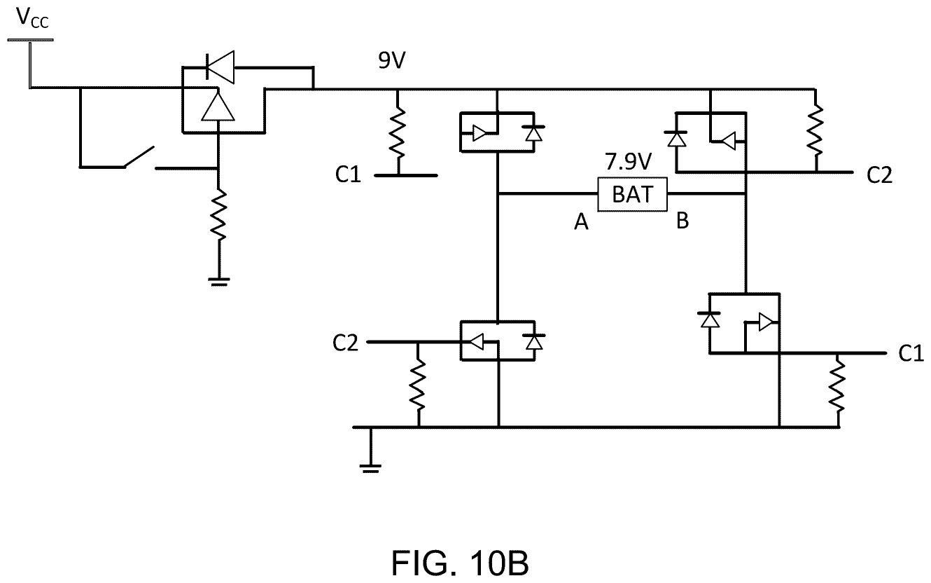

By dividing the charging pad into quadrants and having charging points of the drone battery tied to alternating quadrants, there can only be two possible configurations where the battery is connected. As a result, only swapping between two different current paths instead of four is required for connection of the battery circuit. This swapping of current paths can be done with an H-bridge device, where for charging purposes, a static setting is provided to allow for maximum voltage and unhindered current flow. This is efficient for charging the attached battery as the only losses seen are due to the internal resistance of two H-bridge MOSFET's. Accordingly, FIGS. 10A-10B show exemplary drone station landing quadrants and H-bridge in accordance with various embodiments of the present disclosure.

In various embodiments, the DRV8871 H-bridge driver is chosen because of its small form factor, variety of operating voltages and currents important for universal usage, and the easy-to-use control scheme at varying logic levels. However, in some embodiments, a different H-bridge driver circuit may be used.

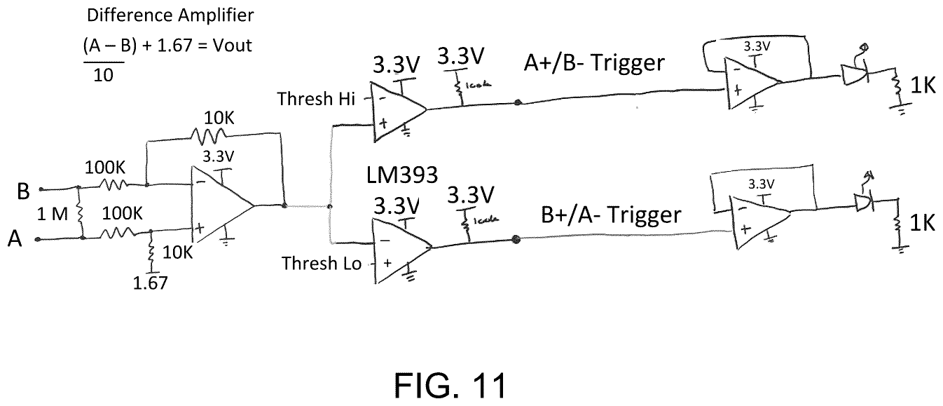

To determine the polarity of the attached battery when contact is made, various embodiments implement a bespoke polarity detection circuit, as illustrated in FIG. 11. Here, when battery voltage is sensed at terminals A and B, the difference of the two points is observed and compared. A difference amplifier with voltage offset and a gain of 1/10 works to scale down battery voltages to a value within the 0-3.3V range seen by the difference amplifier. Since the scaled down difference is offset to the center of the op-amp's operation region, comparators can be used to determine directionality of the circuit using equal and opposite thresholds. For instance, if a 9V battery is attached with terminal A as positive and terminal B as negative, the output of the difference amplifier would be 1.67V+0.9V or approximately 2.6V. With thresholds set at 2.2V and 1.1V, the top comparator would go high and show the A+/B− trigger while the bottom comparator would be low. The thresholds can be adjusted by swapping a resistor in the attached voltage divider.

In various embodiments, the threshold setting circuitry is implemented using TLV272's because of their rail-to-rail output operation but the circuit could be adapted to LM358's for cost efficiency if given enough voltage headroom. In various embodiments, the entire circuit is driven on 3.3V and, as a result, needed rail-to-rail operation and TLV272 are considered inexpensive in this category. LM393s perform well in this system for strictly driving the digital logic at responsive speeds. Additional buffers may be required for supplying current to diagnostic LEDs. In various embodiments, these op-amps can be eliminated entirely if the Raspberry Pico managed the LED driving or LEDs were omitted entirely.

From evaluation and testing, simulation of this circuit yielded promising results for detecting and delivering power to the attached battery. Attempts were made to have the entire system control done using analog design; however, detection of the battery leaving the circuit proved difficult to implement without a timer system or added current measurement. In various embodiments, the circuit H-bridge control is performed using the Raspberry Pico and charge shutoff is implemented using a timer system for simplicity.

During testing, isolation of the ADC reference and supplying of the ADC with an external 3V reference was shown to be effective at reducing reference noise. While a Rigol scope used for measurement is not optimal, there is consistent measurement techniques of 20 MHz bandwidth limiting, smallest ground loops possible, and 10× Probe scaling. There is also an observable decrease in Rms and Peak-to-Peak noise levels between previous and new ADC references-Approximately a 100 mV decrease in Peak-to-Peak noise and 35 mV decrease in Rms noise. This correlates to more precise measurements when using the ADC system and higher effective number of bits (ENOB).

Every voltage reference operated within a typical offset voltage error of 2 mV. There were some errors in layout for the voltage references. Also, the 50 mV reference would raise in voltage over time, presumable due to parasitic capacitance of the circuit board. To mitigate this, the output capacitor was replaced with a 100-ohm resistor to force the op-amp to consistently source small amounts of current and regulate the output. Overall, the voltage references performed well considering the cost of parts and use case.

ADC channel expansion was implemented seamlessly from prototyping. Measurement data had some inaccuracies due to cold solder joints to the ground pour on the PCB. This issue was found and remedied quickly, allowing for accurate measurements of both voltage and current. From testing, the three ADC channels and the 3.3V rail were observed. It was found that the multiplexing system effectively switches the connection for each ADC channel simultaneously then takes a reading for each. This occurs four times for a total of 12 measurements in a single polling of the ADC system. Voltage measurements of ADC0 correspond to Channel 1 of the scope. Current measurements of ADC1 correspond to channel 2 of the scope. Lastly, the battery and charging measurements of ADC2 are on channel 3. Channel 2 experiences larger scaling because the currents seen by the system were practically nothing. However, offsets of the current sense amplifiers can be observed when the channel is opened using the multiplexing system.

The reverse polarity protection board is effective in its main purpose of protection. Given a reverse polarity event with no load, the circuit discharges the onboard capacitors and remains within a diode drop of the ground reference. This shows that the circuit is working as intended; however, sudden capacitor discharge may prove troublesome for sensitive electronics. As a safety feature, this circuit seems to work nicely, If there were repeated reverse polarity events, a smaller resistance or smaller capacitor bank may be used in various embodiments.

Overvoltage clamping was tested observing output voltage and base-emitter voltage on the shunt transistor. Since the onboard systems have many protection systems in place, this feature was a redundancy for safety in development. Accordingly, some embodiments do not populate the board with the overvoltage clamping system for efficiency. Since many of the DC/DC converters are programmable, incorporating voltage clamping on rails powered by them would hinder their ability to be refactored in future development. The 5V rail incorporated this system but its inclusion on other rails was ignored and not populated. Given a 4.7V Zener, conduction starts occurring but does not fully activate the clamp until the base-emitter voltage reaches approximately 1.4V. This clamps the voltage to 5.6V without issue.

Control of the programmable DC/DC converters using the I2C device system is streamlined and developer friendly. Outputs of the DC/DC converters are accurate to their programming and quite precise. To test the extent of the EVM and drivers capabilities, a test script was implemented to iterate from 20V to 3.3V in various and sporadic steps. Every setting of the EVM can be queried and relays accurate information for the DC/DC converter control system.

The voltage and current measurement system works well for the desired use case. Voltage and current readings are well within a 5% accuracy tolerance. There are potential design flaws that could be revised going forward to improve accuracy and precision, However, the implemented measurement system is functional and safe. Large thermal relief on the ground plane makes solder connections poor for capacitors on the ADC measurement system. This can be remedied on a case-by-case basis, or the thermal relief can be smaller in the future. Maintaining the system in their linear region became a balancing act. As a result, edge case measurements show the most inaccuracies. Improvements to the system could be made by removing the weak pull-down resistors on the multiplexing system and instead implementing a transistor that can be activated and provide a short to ground to quickly discharge the ADC lines between multiplexed readings. This would be like how ADCs operate internally. Alternatively, a discrete ADC may be chosen to reduce the footprint of the ADC system onboard and simplify the systems signal development at the expense of higher cost.

The drone charging system works as designed and simulated. A DRV8871 device is programmed for GPIO pins 12 and 13 on the Raspberry Pico with the polarity sensing circuit giving the A+ or B+ triggers to GPIO pins 10 and 11. This allows for a test drone to make contact on the landing pad and signal to the Pico it's orientation. This orientation data is then used in controlling an H-bridge, which spins a motor for demonstration purposes.

The Agisoft script for processing photos works as expected. The script adds the photos, matches and aligns them, builds the depth maps, builds a point cloud, and finally builds the Ortho map or orthophoto mosaic.

The control station GUI also worked as expected, with program hangs at a minimum due to efficient thread management. The GUI is updated only when values are changed to maintain low power usage.

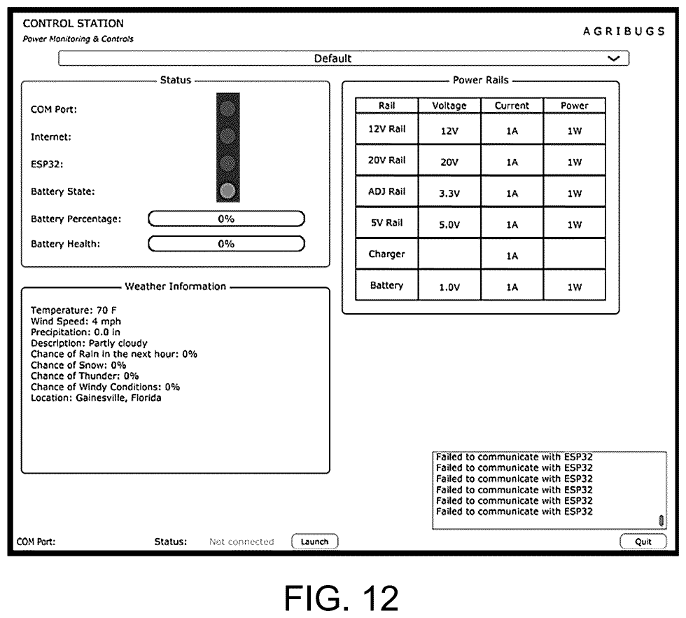

FIG. 12 shows a graphical user interface as a standalone window. The status section of the GUI shows how the peripherals and status of the different devices. For example, green indicators may mean that the devices is connected and functioning properly, while red indicators indicate the devices is not connected. The status is updated on timers and will have some seconds of delay updating the indicator after disconnection or successful connection of a device. The GUI's text size and placement of components on the screen can be adjusted by changing the window size.

The main computer software was effective in creating an efficient graphical user interface and interacting with many parallel systems. GUI and automation processes are portable to any Windows or Linux operating hardware. While the Beelink mini-PC (0.061 TOPS, 0.033 TFLOPS FP32) works well for proof of concept and development, a more powerful and energy efficient computer may be preferred for some embodiments, such as a Jetson Orin AGX 64 GB (275 TOPS, 4.096 TFLOPS FP32) or a Jetson Orin Nano 8 GB (40 TOPS, 1.024 TFLOPS FP32), which is of a similar size and cost of the Beelink while remaining more power efficient (15 W) and approximately thirty times more powerful at floating point arithmetic.

The power management board was a success as a proof of concept and as a development kit for future engineers. In some embodiments, the power management board may integrate EVM circuit directly and reduce a size of the circuit design, creating a united station.

In some embodiments, an off-the-shelf travel router was used to create the local area network while a mobile hotspot was used for internet access. Alternatively, a 4G-LTE modem or Satellite modem may be used for field internet access. For example, a satellite dish antenna can be plugged into the travel router which can create a usable satellite internet connection and affordable data rates with good connectivity.

Based on the testing results, wireless communication of drone images, drone charging, and automatic Ortho map computation have been proven in concept. While there are many features desired for the autonomous drone station, the selection of implemented features has been effective and allows for additional integration and consolidation of the design. Future development can build off the existing design and eventual improvements can be made to favor a smaller form factor, larger system integration, and field ready designs.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A drone station comprising:
a platform support;
a landing platform configured to charge a drone that is positioned on the flat platform, wherein the landing platform is mounted on a top of the platform support;
a Real Time Kinematic (RTK) Global Positioning System (GPS) antenna mounted on the landing platform;
a house computer configured to control and monitor operations of the drone landing platform system that include battery management and communications with the drone;
a dome enclosure surrounding the landing platform that is configured to open and close around the landing platform; and
an internal battery, wherein the internal battery supplies power to the landing platform.

2. The drone station of claim 1, wherein the landing platform contains conductive material for point-to-point charging of the drone that is positioned on the landing platform.

3. The drone station of claim 1, wherein the dome enclosure comprises three separate pieces in which together creates a closed covering for the landing platform.

4. The drone station of claim 1, further comprising solar panels that are configured to supply power to the internal battery.

5. The drone station of claim 1, wherein one or more legs of the platform support contain one or more moisture sensors.

6. The drone station of claim 1, further comprising an aerial drone.

7. The drone station of claim 6, wherein the drone comprise an RTK GPS antenna for communicating with the house computer.

8. The drone station of claim 1, further comprising an alternative power source that is configured to supply power to the internal battery.

9. The drone station of claim 1, further comprising one or more LIDAR sensors integrated into the platform support.

10. The drone station of claim 1, wherein the house computer is configured to deploy a web server graphical user interface (GUI) for interaction with the drone by a remote user.

11. The drone station of claim 10, wherein the house computer is configured to communicate with the drone for flight control and mission planning.

12. The drone station of claim 10, wherein the dome enclosure is configured to be opened and closed remotely via the web server GUI.

13. The drone station of claim 1, further comprising a router and modem that is configured to create a local area network having internet access.

14. The drone station of claim 13, wherein the modem is a satellite modem.

15. The drone station of claim 13, wherein the modem is configured to provide LAN/WAN connectivity.

16. The drone station of claim 15, wherein the modem comprises a 4G-LTE modem.

17. The drone station of claim 13, wherein the house computer is configured to communicate with the drone using the local area network.

18. The drone station of claim 1, wherein the house computer is configured to execute a drone flight state machine to determine whether the drone is ready to fly.

19. The drone station of claim 18, wherein the house computer is configured to check weather data to determine whether the drone is ready to fly, a connection status of the drone, and/or whether the drone has already completed a flight within an operational time window.

20. The drone station of claim 1, further comprising a camera system.

21. The drone station of claim 20, wherein the camera system is configured to capture a 360 degree view around the landing platform.

22. The drone station of claim 21, wherein the house computer is configured to track weather conditions using the camera system.

23. The drone station of claim 1, further comprising an auxiliary landing pad containing conductive material for point-to-point charging of an unmanned ground vehicle that is positioned on the auxiliary landing pad, wherein the auxiliary landing pad is positioned below the landing pad between legs of the platform support.

24. The drone station of claim 23, wherein the house computer is configured to use imaging data acquired from the drone and the unmanned ground vehicle in parallel for environmental reconstruction.

25. The drone station of claim 23, wherein the house computer is configured to send instructions for capturing data for accurate and precise environmental reconstruction to the drone and the unmanned ground vehicle.

26. The drone station of claim 23, further comprising auxiliary solar panels that are configured to provide shelter to the auxiliary landing pad and the unmanned ground vehicle when deposed on the auxiliary landing pad by being attached to legs of the support platform, wherein the auxiliary solar panels are configured to generate electrical power for the drone station from solar radiation.

27. The drone station of claim 26, wherein the unmanned ground vehicle is configured to collect a sample from an agricultural field and place the sample in an enclosure on top of the unmanned ground vehicle, wherein the drone station is configured to acquire an image of the collected sample when the unmanned ground vehicle is disposed on the auxiliary landing pad underneath the drone station.

28. The drone station of claim 1, further comprising an underground battery storage device that is configured to supply power to the internal battery.
